(19) United States
(12) Patent Application Publication
(10) Pub. No.: US 2011/0114532 A1
(43) Pub. Date: May 19, 2011

(54) METHOD OF MANUFACTURING CELLULAR FILMS DIRECTLY

(75) Inventors: Alain Francois, Hinges (FR); Philippe Lefevre, Haverskerque (FR); Denis Simon, Lefrinckoucke (FR)

(73) Assignee: ROQUETTE FRERES, Lestrem (FR)

(21) Appl. No.: 13/002,721

(22) PCT Filed: Jul. 15, 2009
(86) PCT No.: PCT/FR2009/051402

§ 371 Date: Jan. 5, 2011

(30) Foreign Application Priority Data
Jul. 16, 2008 (FR) 0854852

(51) Int. Cl. B65D 85/42; B29C 39/38

(52) U.S. Cl. 206/528; 264/219; 264/319; 264/330

(57) ABSTRACT

A method of manufacturing a film (6) includes the following steps: a) a film-forming mixture containing at least one film-forming agent is prepared; b) a dose of the mixture is deposited in a cell (4) of a cellular substrate (2), the mixture having a viscosity ranging from 1 to 8000 mPa·s at the temperature of the film-forming mixture during the deposition; c) the mixture is cured so as to obtain a film (6); and d) the cell (4) is closed off by a hermetic sealing element (3). A device (1) especially suitable for the method and a device intended to implement the method are also described.

The present invention relates to a process for obtaining a film capable of being applied especially in the food or pharmaceutical industry; the invention also relates to a cavity support especially intended for the implementation of said process.

The process according to the invention is particularly well suited to the preparation of films containing active principles or aromatic films. These films may be envisaged with a support, such is the case for patches, or without a support in the case, for example, of flavor sheets. Flavor sheets are very thin sheets which, depending on the desired application, may be placed on the tongue in the case of oral films, and melt instantly while diffusing a flavor, for example of mint. The films may also be suitable for pharmaceutical applications that do not specifically require instantaneous melting of the film, mention may be made, for example, of the controlled release of active principles or mucoadhesion.

A process for obtaining oral films from technologies derived from magnetic strips for videos in particular is known to those skilled in the art of the pharmaceutical or food industries.

The prior art processes generally comprise the following steps:
a first step that makes it possible to obtain a reel of film from a film-forming mixture,
a second step during which the reel is cut to the desired dimensions, and
a third step of packaging the films obtained.

The first step consists of spreading said mixture as a wide strip on the surface of a plastic film that acts as a support. It is followed by a phase of drying the thin layer of mixture with a stream of air. The drying phase requires monitoring and treatment of the air pulsed over the strip of film, whether this is within the context of films intended for a food or pharmaceutical application. The pulsed air may, in certain cases, require treatment before being released into the environment. Such is the case, in particular, for the use of products that are toxic for man or the environment. Indeed, the air may be laden with toxic substances due to volatile additives from the mixture or microparticles emitted by the dried sprays of mixture or by the strip of film obtained passing into the gas phase.

At the end of this first step, the strip of film and its support are wound up so as to obtain a reel of film. Less frequently and depending on the plasticity characteristics of the film, the strip of film may be obtained and wound on to a reel without the support. However, the absence of a support accentuates the risk of the strip breaking.

During a second step, the reel of film is unwound and the strip of film is separated from its support in order to be cut to the desired shape and size. This step is a source of many losses since, depending on the cuts made, the entire width of the strip is not necessarily used. Thus, before being discarded, all the scrap must be reprocessed depending on the level of toxicity of the compounds or active principles used. During this step, it is common to cut up the strip of film into several small strips of film having the desired final width, to group together these small strips of film before cutting them to the desired length. At the end of the cutting operation, the films are therefore grouped together in a stack.

The films obtained are then stored while waiting to be packaged.

The packaging is a crucial step of this process since it consists of a separation of a given number of films. The step is tricky in that it consists in separating films of a few microns in thickness without splitting them or degrading them.

Although in the food sector, multidose packaging is very widespread, in the pharmaceutical sector, generally, packaging defines a pharmaceutically active dose. Consequently, this definition of the number of films per packaging is essential since it is a question of products which, depending on the dose ingested, will prove to be either dangerous or beneficial. The packagings are generally provided for a single film.

The idea of dosage per film therefore takes on a major importance. However, the dose of active principle contained in a film obtained by this prior art process also depends (i) on the mixing carried out at the beginning of manufacture, (ii) on the control of the thickness of the strip of film during the spreading step, (iii) on the area of the small strip of film then of the cut film and (iv) on the integrity of the individualized and packaged film. Consequently, the guarantee of a given dose per packaging requires numerous check points at each step of the production line.

The steps of the prior art processes are generally carried out by machines that are independent of one another and therefore require, on the one hand, the transport of the reels of film, then of the small strips of film from one machine to the next but also, and above all, control of the ambient conditions since the reels are stored between each step of the process. Water-soluble films such as, in particular, the oral films are very sensitive to ambient moisture. Therefore, any variation in the ambient moisture content during their manufacture may lead to the agglomeration of the strips of film to one another and a loss of the entire production. Similarly, under dry conditions, since water has a plasticizing role, the films may be embrittled. Thus, the reduction in plasticity of the films renders any handling even trickier with risks of the film breaking which may lead to the shutdown of the production line.

Furthermore, the numerous handling operations whether it is the winding and unwinding of the reels or the separation of the strips of film from their support, the cutting of the strips into small strips then of the small strips into films and finally the separation of the films obtained during the packaging operation, are a source of many losses along the production line.

Similar processes are described in the prior art, in particular in patent application US 2004/0076799.

The present invention makes it possible to respond to the various problems of the prior art by proposing a continuous flow process that makes it possible to obtain microdosed films in individual packaging. The process according to the invention comprises the following steps:
a) preparing a film-forming mixture comprising at least one film-forming agent,
b) depositing a dose of said mixture into a cavity of a cavity support, the mixture having a viscosity of 1 to 8000 mPa·s at the temperature of said film-forming mixture during said deposition step b), preferably a viscosity of 10 to 5500 mPa·s,
c) curing of said mixture so as to obtain a film,
d) closing said cavity by a hermetic closure means.

The difficulties linked to the numerous handling operations of the strips and small strips of films or of the films in the prior art process, a source of losses or of dosage errors, are not observed in the process according to the invention. Indeed, the film is directly obtained in its future packaging. Similarly, in the absence of a cutting operation, there is no loss of products or of active principle. Furthermore, the film may be of the desired shape and thickness depending on the cavity chosen and the amount of mixture introduced into this cavity.

The term “film” is understood to mean a thin and flat product having an essentially flat surface, having a maximum thickness of 3000 microns in which the thickness is very small compared to the length and to the width. The film within the meaning of the present invention preferably has a thickness between 10 and 3000 microns, preferably between 20 and 2000 microns.

Furthermore, there are no problems of storage of the products along the production line since the process is carried out continuously. Moreover, once the film is obtained in the cavity, this cavity is closed off hermetically by sealing for example and may therefore be stored without any particular precautions.

The total absence of handling operations, of losses along the line and of storage of intermediate products, considerably reduces the manufacturing cost, whether in the case of use of products that are dangerous for the handlers or for the environment, or in the case of non-recyclable or expensive products. In fact, the volume of air to be treated along the production line is considerably reduced.

Moreover, the dosage per packaging is reliable since the dose introduced into the packaging is accurately determined and determinable all along the production line.

The process according to the invention therefore makes possible a reduction in the production cost, an increase in the level of accuracy and of control of the dosages and also of the reproducibility while being suitable for the manufacture of many types of films, for instance free films such as oral films or flavor films, films comprising a support such as patches in particular.

The difficulties overcome by the applicant are, on the one hand, the production of a film-forming mixture that enables, due to its viscosity, good flow at the time the cavity is filled and good spreading in order to form a film. The expression “film-forming agent or substance” is understood to mean any substance capable of forming a film.

The prior art processes respond to different constraints and therefore use film-forming mixtures with different physicochemical features. Indeed, these processes require a high and precise viscosity for each mixture. At a slightly lower viscosity level, the film-forming composition flows outside of the support. And at a slightly higher viscosity level, the thickness of the strip of film is not constant.

The thickness of the layer intended to form the film after curing may be from 0.01 to 10 mm depending on the nature of the film-forming mixture and the application of the film and therefore depending on the loss of volume associated with the curing of the mixture, therefore with the obtaining of the film.

The process according to the invention is rendered possible by a mixture that has, during its deposition, a viscosity that ranges from 1 to 8000 mPa·s and preferably 10 to 5500 mPa·s at the temperature of the mixture at the moment of deposition and more preferably still from 50 to 1500 mPa·s. This process is particularly advantageous in that it allows the use of mixtures of varied viscosities for the production of films.

The desired viscosity is achieved in the case of a starch-based film-forming mixture at temperatures ranging from 10 to 95° C. For high molecular weight polyethylene glycols, it is achieved at temperatures above around 50° C., preferably between 60 to 90° C.

The viscosity within the meaning of the present invention is a Brookfield viscosity determined by means, for example, of an RDVD-I+ Brookfield viscometer (Brookfield Engineering Laboratories, Inc., Middleboro, Mass., USA) using one of the spindles referenced RV1, RV2, RV3, RV4, RV5, RV6 or RV7 and without the use of the equipment referred to as “Helipath Stand”. The rotation of the spindle is set at 20 rpm. The spindle, RV1 to RV7, is chosen so that the viscosity value displayed is between 10% and 100% of the total viscosity scale possible with said spindle, as indicated by the manufacturer. To carry out this viscosity measurement, 300 ml of the film-forming mixture are placed in a 400 ml beaker of low shape (diameter around 7.5 cm). The viscosity value is taken at the end of the third rotation. The measurement will be carried out by following all the recommendation given by this manufacturer in order to obtain a reliable viscosity measurement, for example in the manual “Operating Instructions, Manual No. M/92-021-M0101, Brookfield Digital Viscometer, Model DV-I+).

According to one feature of the invention, steps b) and c) of the process are repeated at least once before step d). Since this process can be adapted to aqueous and/or organic mixtures with film-forming agents of different natures, the active principles or flavors which may be used are very varied. Thus, by a repetition of steps b) and c), the process according to the invention enables one and the same film to be obtained from products or active principles that are not miscible with one another or that are incompatible as a mixture. Specifically, in this case, the film is manufactured in two goes, from two film-forming mixtures of different characteristics.

According to another advantageous variant, the process according to the invention provides a step of depositing in said cavity a granular or solid compound or a semi-liquid or liquid preparation before step d). In other words, the deposition of granular compounds, solids or liquids may be carried out before or after step b) or even after step c). Thus, a compound or a liquid or semi-liquid composition may be included between the two layers of film in the case where steps b) and c) are repeated. Furthermore, in the case of a deposition of the film-forming mixture on to a detachable support such as a flexible sheet reversibly bound to the bottom of said cavity, the compound or composition may be included between the layer of film-forming mixture and the flexible sheet. In both the aforementioned cases, the compound or the composition may be released in a controlled manner on melting of the film layer(s). The particular case of deposition of a semi-liquid or liquid, or even granular or solid, substance may be the printing of the film or of a support contained in the cavity.

Thus, according to one advantageous variant, said step of depositing a granular or solid compound or a semi-liquid or liquid preparation is a printing step. Thus, the film may be printed in order to indicate the product contained, the dosage at any letter or in the form of a symbol before said cavity is closed off. The printing of an image, of a photo or of a design in the case of a film that is not intended for a pharmaceutical application can also be envisaged.

Advantageously, said printing step is carried out before step c) of curing said mixture. Thus, depending on the desired effect and on the printing system chosen, the printing may be envisaged on the uncured mixture or on the film after step c) of curing the mixture.

More advantageously still, said printing step is carried out before the deposition step b). Indeed, in the case of a film combined with a support, the printing may be envisaged alternately between the support and the mixture or on the mixture after deposition.

The printing may be carried out by an ink-jet printer or any other means enabling a projection of a colored composition or composition having a texture or an opacity different from said film-forming mixture so as to enable a pattern, an image, a photo or text to be fixed to said film.

Advantageously, the curing step c) of the process according to the invention is a step of cooling the mixture to ambient temperature. The expression “curing the mixture” is understood to mean the passage of this mixture from a liquid or viscous phase to a solid phase. For example, during the use of film-forming agents that melt under the action of heat and become liquid without incorporation of solvents. Such is the case, in particular, for high molecular weight polyethylene glycols (PEGs) and derivatives thereof, polyethylene oxides and derivatives thereof, glycerides, polyglycerides and derivatives thereof.

Depending on the physicochemical characteristics of the film-forming mixture and especially the volatility of the solvent of said film-forming mixture, the process makes provision for the curing step c) to be a step of evaporating a solvent contained in said film-forming mixture.

Since the process can be applied to all types of film-forming mixture, in the case of an organic mixture in which the solvent is an aqueous-alcoholic solution comprising ethanol, propanol, isopropanol, or any other volatile solvent, the simple evaporation of the solvent at ambient temperature is sufficient for the curing thereof. Such is the case when the film-forming agent is a cellulose derivative such as hydroxypropyl cellulose, ethyl cellulose, methyl cellulose, cellulose acetate phthalate, cellulose acetate, a polymethacrylate, or a polyvinyl acetate phthalate.

When the film-forming agent is a hydrophilic polymer, water is used as solvent, the polymer possibly being a polymer of plant origin or of synthetic origin, alone or as a mixture, for example and without this list being limiting, extracts of algae such as alginates and carrageenans, modified celluloses, polysaccharides such as pullulan, gelatin, pectin, gums of plant or animal origin, polyethylene glycols, poloxamers, native starches, modified and/or hydrolyzed starches, maltodextrins, polyvinyl alcohol and its derivatives, etc.

Advantageously, the step of evaporating the solvent is carried out by increasing the temperature of the mixture, by varying the pressure or by a combination thereof. The step of evaporating the solvent may be carried out at reduced temperature and at reduced pressure so as to avoid phenomena of sublimation of active principles or in order to maintain their stability in the case of use of compounds that are labile or very reactive to heat. The means for heating the mixture could be stoving of the mixture or microwave or infrared heating or a combination of these means.

The curing step c) is crucial since the drying of the film must be controlled, that is to say to a solvent content which simultaneously gives it a certain structure, a certain flexibility and a stability at an equilibrium relative humidity between 20 and 80%. Thus, in the case of an aqueous solvent, the water content of the film will, in the majority of cases, be less than 20%, preferably of the order of 5 to 10% in order to permit good preservation of the film without resulting in the crazing of this film. Indeed, the film-forming structure must be preserved but the drying must preferably be carried out without bonding of the film in the cavity.

Preferably, the film-forming mixture comprises:
from 40 to 99% by weight of film-forming agent,
at least 1% by weight of an additive.

The term “additive” is understood to mean a flavor, a sweetener, a plasticizer, a humectant, a surfactant, an active principle or any molecule for which the film-forming agent is capable of constituting a carrier.

Preferably, the film-forming mixture comprises an aqueous or organic solvent. Advantageously, the film-forming agent comprises a starch or a mixture of starches.

More preferably, the starch or at least one starch of the mixture of starches is derived from a legume.

The process is particularly suitable for the film-forming mixtures obtained from mixtures of starches of various origins so as to adjust the content of amylase between 25 and 45%. For example, mixes of amylopectin-rich starches (known as waxy starches) and of amylose-rich starches. The starch or at least one starch of the mixture may in particular have undergone at least one modification treatment chosen from the group comprising chemical treatments, physical treatments and enzymatic treatments.

The chemical treatments comprise in particular all the known operations of esterification, of etherification, of crosslinking or of hydrolysis by acid, oxidizing or enzymatic routes. The chemical treatments which are particularly suitable for obtaining a film-forming solution are the “stabilizing” treatments, which are hydroxypropylation or acetylation, it being possible for these treatments optionally to be supplemented by a liquefaction or a controlled hydrolysis, for example by acid treatment.

The process is more particularly suited to the film-forming mixtures obtained from the starch of legumes. The term “legumes” is understood to mean the plants belonging to the Caesalpinaceae, Mimosaceae or Papilionaceae families and in particular any plant belonging to the Papilionaceae family, such as, for example, pea, bean, broad bean, horse bean, lentil, alfalfa, clover or lupin.

This definition includes in particular all the plants described in any one of the tables present in the paper by R. Hoover et al. entitled “Composition, Structure, Functionality and Chemical Modification of Legume Starches: A Review”.

Advantageously, it is pea, the term “pea” in this instance being considered in its broadest sense and including in particular:
all the wild varieties of smooth pea and
all the mutant varieties of smooth pea and of wrinkled pea, this being the case whatever the uses for which said varieties are generally intended (human food, animal nutrition and/or other uses).

Said mutant varieties are in particular those referred to as “r mutants”, “rb mutants”, “rug3 mutants”, rug4 mutants“, “rug5 mutants” and “lam mutants” as described in the paper by C-L Heydley et al. entitled “Developing Novel Pea Starches”, Proceedings of the Symposium of the Industrial Biochemistry and Biotechnology Group of the Biochemical Society, 1996, pp. 77-87.

The expression “legume starch” is understood to mean any composition extracted in whatever way from a legume and in particular from a Papilionaceae, the starch content of which is greater than 40%, preferably greater than 50% and more preferably still greater than 75%, these percentages being expressed by dry weight with respect to the dry weight of said composition.

The process can be applied to films having a thickness of 10 to 3000 μm, preferably from 20 to 2000 μm, more preferably from 30 to 500 μm and more preferably still from 35 to 200 μm, both in the case of films obtained by a direct deposition of the mixture on the bottom of the cavity and on a support held at the bottom of the cavity. Hence, this process can be applied to the manufacture of films whether these are food or pharmaceutical films, to oral films but also to films with a support such as transdermal patches that allow the administration of an active principle by application of the patch to the skin or any other application in which obtaining a film of such a thickness is advantageous. For example, topical pharmaceutical films, pharmaceutical or cosmetic films or patches to be fixed to a mucus membrane, to a wound or to the skin as is, or to be added to another cosmetic product before use, food films consumed as is or which will be deposited on a food before consumption. The process is also particularly suitable for producing highly water-soluble films, which films will be able to be dissolved in water or any other drink before consumption.

After curing of the film, depending on the film-forming agent chosen and depending on the solvent used, the active agent will be able to be in the form of a solid dispersion, in crystalline and/or amorphous form. This has the advantage of enabling an adjustment of the solubilization of this active agent.

The additive may be a flavor, an active principle, an excipient, a food or vitamin supplement, a medicinal extract, a cosmetic active agent, a colorant, a pigment, a pH corrector, a plant extract, a veterinary active agent, or food supplements.

The active principles that can be envisaged are those for which the application may be transdermal such as, in particular, antifungals, antimycotics, corticoids, anti-acne agents, antibiotics, antiparasitics, antihistamines, keratolytics, antiseptics, repellant molecules, rubefacients, depigmenting agents, anti-inflammatories, antirhumatics, analgesics, topical agents in phlebology, anti-obesity active agents, contraceptives, growth regulators; hormones, antinauseants, etc.

Or oral-application active principles for a topical or systemic action such as antiseptics, antifungals, antimycotics, antibiotics, antihistamines, anti-inflammatories, antimigraine agents, antidiarrhetics, analgesics, antidepressants, local anesthetics, antiparasitics, antipyretics, antispasmodics, or any other substance having curative or preventative properties with respect to human or animal diseases and also any product which may be administered to man or to animals with a view to establishing a medical diagnosis such as a molecule that acts as a marker or tracer, or to restoring, correcting or modifying their organic functions.

Necessarily, since the film-forming mixtures may be of varied nature, the material of the cavity support chosen should be inert with respect to the film-forming mixture and especially with respect to the compound or compounds contained in this mixture.

Advantageously, the process according to the invention comprises a step of producing said cavity support.

Since said cavity support can be produced as a function of the desired film, this process may be used for films of any shape and of any size.

The cavity support according to the invention is especially adapted to the implementation of the process according to the invention and is, in particular, especially intended to contain a film having a thickness of 10 to 3000 μm or a structure which may reach 15 000 μm.

The invention also relates to a device comprising said cavity support.

According to the invention, this device comprises a cavity support provided with a cavity and a means of closing said cavity support, said cavity being surrounded by a transverse flange comprising a hermetic sealing zone, said cavity being provided with an essentially flat base, said base (4b) having an area greater than 1 cm² per millimeter of depth of said cavity (4). This ratio enables easy accessibility of the film and therefore facilitates the gripping thereof. The cavity according to the invention makes it possible both to have sufficient depth to receive the film-forming composition before the step of curing the mixture and a small enough depth to facilitate the gripping of the film without however degrading it or embrittling it. Indeed, the volume of the film-forming composition before curing may be much larger than the volume of the film obtained due to the evaporation of the solvent or the polymerization of the film-forming agent. Thus, for an area of the base of the cavity of 6 cm², it may have a height of 1 to 2 mm in the case of an orodispersible film. In the case of a patch, for an area of 64 cm² the cavity may have a depth of 1 cm.

Advantageously, said cavity has a depth of less than 2 cm, preferably a depth of 0.02 to 1 cm and more preferably from 0.05 mm to 10 mm, more preferably still from 0.2 to 2 mm.

The expression “essentially flat” is understood to mean a structure that generally has a flat shape. Thus, the base of the cavity may be slightly curved or provided with microprotrusions or microprotuberances, or even microcavities or shallow grooves. A curvature of the base of the cavity allows an increase in the thickness of the film and thus in the dose of active principle or of active agent contained in a film while retaining the same area and the same thickness at its edges. The microprotrusions or microcavities or microprotuberances or even the shallow grooves themselves make it possible, via the creation of a non-homogeneous surface, to prevent the adhesion of the film to the base of the cavity or at the very least to facilitate the detachment thereof. These microcavities or shallow grooves may be filled with minute quantities of colored substances, in liquid or powder form, capable of adhering to the film-forming composition after deposition so as to create a structure that forms a pattern on the surface of the film as an overthickness.

Advantageously, the cavity is provided with a deformation zone. According to a first preferred variant, the side wall of the cavity is provided with a deformation zone. The deformation zone occupies the entire height of the side wall or a central or peripheral zone of its height. This deformation zone makes it possible to reduce the height of the cavity and thus to improve the accessibility of the film according to the invention, by exerting a force on the lower edge or on the base of the cavity. According to a second preferred variant, the cavity comprises a deformation zone at its base. This deformation zone makes it possible to facilitate the recovery of the film. Advantageously, the deformation zone is located at a peripheral edge of the base of the cavity delimiting, at its center, a deposition zone. Alternatively, the deformation zone extends over the entire surface area of the base of the cavity. The presence of a peripheral edge allows a delimitation of the periphery of the base of the cavity and to thus accurately regulate the capacity of the deposition zone.

According to one advantageous variant, the base is provided with a peripheral groove. This groove makes it possible to raise the base of the cavity with respect to the flange and thus to facilitate the access to the film while reducing the volume of the cavity.

The preferred features of the cavity support are the following:
depth of less than 2 cm, preferably a depth of 0.02 to 1 cm and more preferably from 0.05 mm to 10 mm, more preferably still from 0.1 to 5 mm,
area of the base of the cavity ranging from 1 to 500 cm², preferably from 2 to 250 cm² and more preferably from 3 to 125 cm².

The thermoformed materials used may be polyvinyl chloride (PVC), polyethylene terephthalate (PET), polyamides (PA), polyvinylidene chloride (PVDC), polystyrene (PS), or polypropylene, preferably PVC.

The deformation zones may be constituted of one of the polymers mentioned previously or a mixture thereof or any other polymer that gives it elasticity characteristics.

The cavities may also be obtained by pressure forming of aluminum or of an alloy comprising aluminum.

Advantageously, the cavity of the device may be provided with a detachable support positioned at the base of the cavity and intended to be covered at least partly by the film. Said detachable support may advantageously be reversibly bound to the base of said cavity. The detachable support is chosen from a woven or nonwoven textile or a flexible plastic or metal sheet. The product obtained may be a component included in a film temporarily (by destruction or reduction of the film for example) or permanently, the film itself adhering to the support.

According to one variant, said detachable support is provided, on at least one of its edges, with an adhesion zone intended to be applied and to adhere to a surface. In this case, the product obtained may be a film comprising a support such as a patch. This device therefore makes it possible to have a directly packaged patch obtained in a single step with no risk of weakening the cohesion of the film-forming mixture/support assembly.

Advantageously, the invention relates to a device containing a film. The term “film” is understood to mean a free film, a film adhering to a support or an assembly of several layers of film-forming mixtures that adhere to one another and form one and the same film.

Another subject of the invention is an assembly formed by joining several devices forming a blister pack, the devices of the blister pack possibly being separated by at least one tearable separation line.

Moreover, the invention also relates to a unit for carrying out the process comprising the succession of the following means:
means for manufacturing and homogenizing the film-forming mixture,
means for depositing the film-forming mixture,
means for curing the mixture,
means for hermetically closing the cavities and if desired
printing means.

According to one variant, the unit could advantageously be provided with means for producing the device especially intended for the implementation of the process.

The device according to the invention is more fully described and illustrated below.

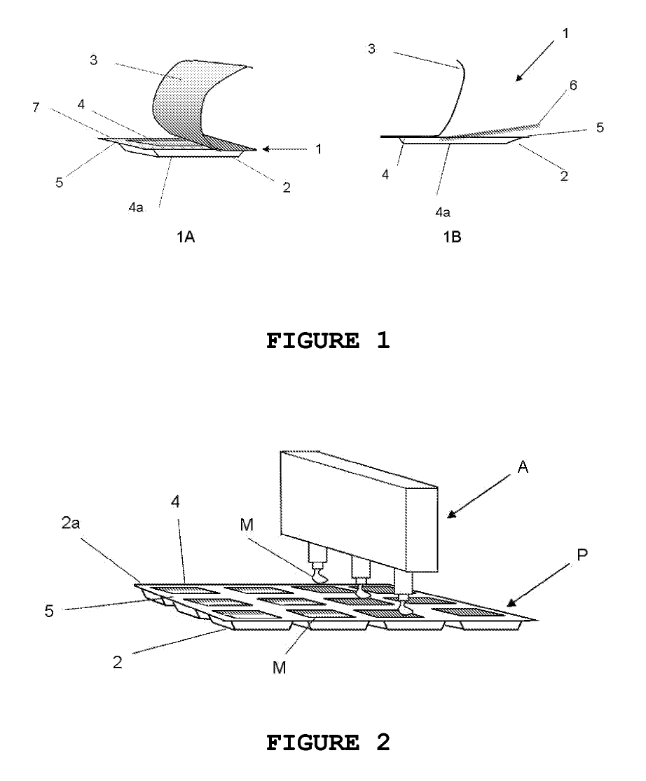

FIGS. 1A and 1B are views of a first variant of the device, FIG. 1A is a perspective view of the side face of the first variant of the device composed of a cavity support and of a closure sheet; and FIG. 1B is a side cross-sectional view of a first variant of the device containing a film, the closure means of which is partially open;

FIG. 2 is a perspective view of a portion of a unit for depositing a film-forming mixture into the cavities of a cavity support blister pack;

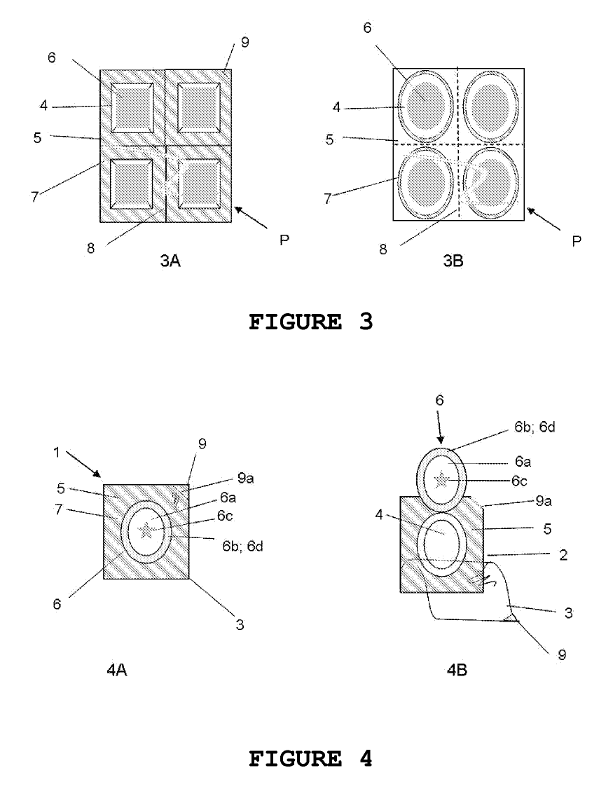

FIGS. 3A and 3B are top views of blister packs containing several separable devices, each cavity of each device containing a film;

FIGS. 4A and 4B are top views of devices containing a patch, a closed device in FIG. 4A and an open device with the patch partially taken out of the cavity in FIG. 4B;

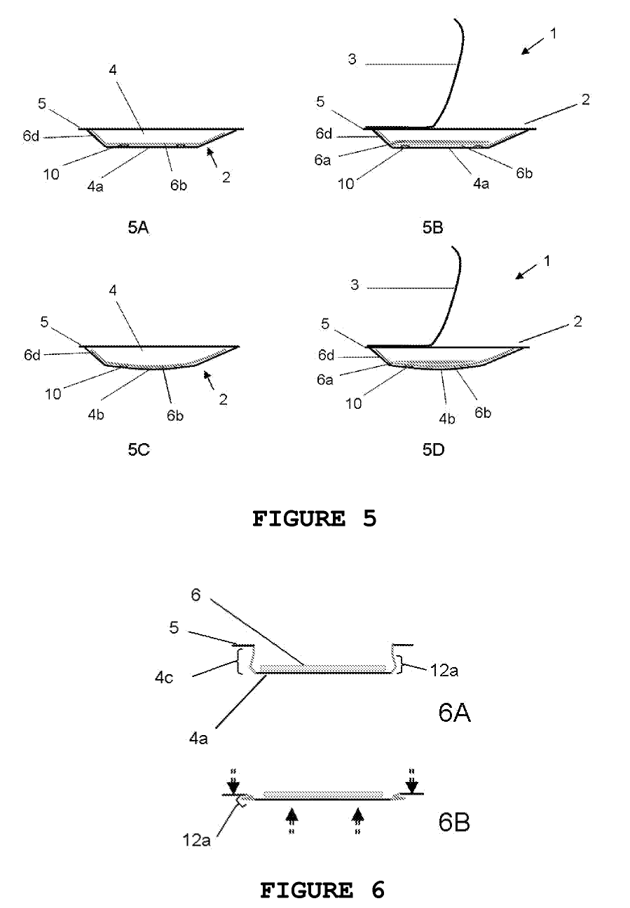

FIG. 5 illustrates side cross-sectional views of variants of the device according to the invention, FIG. 5A being a view of a second variant of the empty cavity support and FIG. 5B illustrating the same device partially open and containing a patch. FIGS. 5C and 5D are side cross-sectional views of a third variant of the device according to the invention, FIG. 5C being a view of the empty cavity support and FIG. 5D illustrating the device partially open and containing a patch;

FIG. 6 illustrates side cross-sectional views of a fourth variant of the device according to the invention comprising deformation zones located over the entire height of the cavity wall, FIG. 6A being an open device equipped with a deformation zone in the cavity wall in a non-deformed conformation and FIG. 6B being a view of the device in a compressed conformation with deformation of the side wall under the exertion of compressive forces;

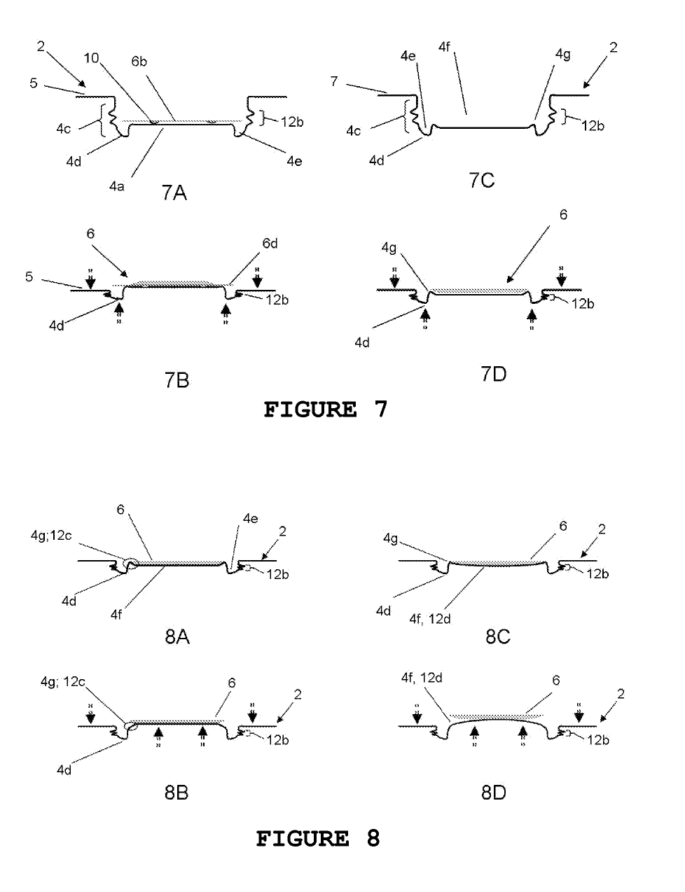

FIG. 7 illustrates cross-sectional views of fifth and sixth variants of the device according to the invention comprising deformation zones located in a portion of the cavity wall, FIGS. 7A and 7C illustrating a view of an empty cavity support before deformation; FIGS. 7B and 7D illustrating the open device in a compressed conformation with a deformation of the cavity wall and containing a patch or a film;

FIG. 8 is composed of cross-sectional views of seventh and eighth variants of the device which are open and contain a film; these devices being equipped with a deformation zone in the cavity wall in a compressed conformation and with a deformation zone in the base of the cavity, FIGS. 8A and 8C illustrating devices that have the deformation zone at the base of the cavity in a relaxed conformation, FIGS. 8B and 8D illustrating the devices having their deformation zones at the base of the cavity in a deformed conformation following the exertion of a force on the base of the cavity.

FIG. 1A illustrates a device 1 composed of two structures, a cavity support 2 and a closure means in the form of a flexible sheet 3. The cavity support 2 is hollowed out by a cavity 4, the sheet 3 being welded at its periphery to the weld zone 7 of the flange 5 of the cavity support 2. According to the first variant of the device, the base 4a of the cavity 4 is flat.

The closure means 3 may be a sheet made of aluminum, of plastic or any other material capable of being bonded or sealed to the cavity support 2 so as to give protection with respect to light, heat, moisture or any other condition liable to be detrimental to the correct preservation of the contents.

The device according to the invention is especially intended to contain an essentially flat structure having a thickness of the order of 10 μm to 5000 μm such as, in particular, a film 6 (FIG. 1B). The film 6 illustrated in FIG. 1B is composed of two different superposed structures that form one and the same film. It is thus possible to envisage the use of different film-forming mixtures with two different active principles or two different flavors, or even a film that includes a liquid or granular substance within it.

The step of depositing the mixture M may be carried out by a wide range of systems for dispensing doses A (FIG. 2) into the cavities 4 of a blister pack P. Mention may especially be made of the metering or filling type machine sold by Industria Macchine Automatiche S.p.A. (I.M.A S.p.A.).

The number of films manufactured simultaneously will depend on the width of the blister packs P that can be used and therefore on the capacity of the systems A for depositing doses and also of the systems for curing the mixture.

Following the deposition, the mixture spreads over the base 4a of the cavity 4. This spreading step depends on the viscosity of the mixture which may be from 1 to 8000 mPa·s at the temperature of the film-forming mixture during the deposition thereof. It also depends on the surface tension of the mixture which will be optimized by the addition of wetting agents or surfactants. For the highest viscosities, a system for vibrating the blister pack may be envisaged to facilitate the spreading of the mixture.

The thickness of the layer intended to form the film after curing may be from 0.01 to 10 mm depending on the nature of the film-forming mixture and the application of the film and therefore depending on the loss of volume associated with the curing of the mixture and therefore with the obtaining of the film.

The choice of the technique for curing the mixture so as to form the film depends on the mixture used. For solvent-free mixtures, the curing may be envisaged simply by leaving the mixture to cool.

In the case of a mixture with a volatile solvent, the curing may be carried out by simple evaporation of the solvent at ambient temperature. Nevertheless, the use of heating and of a reduction in pressure makes it possible to accelerate the curing.

In the case of aqueous mixtures, the choice of the curing technique via evaporation of the water may be varied, for example, by the use of an oven, infrared or microwave heating or even by a reduction in pressure.

The technique chosen must allow the structure of the film to be maintained.

After obtaining the film, a new cycle comprising the deposition and curing steps b) and c) can be envisaged, for example in the case of integrating two active principles that are incompatible or that have different physicochemical qualities so that they cannot be integrated into the same film-forming mixture. Since the second layer of film is applied in liquid form, it therefore adheres to the first layer and thus gives unity of structure to the assembly.

The cavities 4 may be closed off by sealing or bonding over a sealing zone 7 of a closure means 3 which may be a flexible or rigid seat over the entire surface area of the flanges 5 separating the cavities 4 (FIG. 3A) or over the circumference of the cavity (FIG. 3B).

The devices may be packaged in the form of blister packs P (FIG. 3) or individually in the form of devices 1 (FIG. 4). When they are assembled as a blister pack P, the devices 1 may be able to be individualized by the formation of tearable separation lines 8 (FIG. 3).

When the sealing zone 7 extends over the entire flange 5, a zone 9 of the flange 5 is breakable so as to facilitate the opening of the device 1 (FIG. 3A and FIG. 4).

The breakable zone 9 is obtained by establishing a tearable separation line 9a.

The cavity 4 from FIGS. 4A and 4B contains a film with a support, the case of a patch 6 is illustrated by way of example. This patch is formed of a film-forming zone 6a and of a support 6b in the form of a pressure-sensitive adhesive sheet.

Printing 6c may be envisaged on the patch 6, in the same way as on a film without a support. In the case of patches, the printing zone 6c may be made on the support 6b or directly on the film-forming zone 6a.

Printing on the film-forming zone may be obtained from a composition for printing a color or a texture different from that used for obtaining the film-forming zone. The printing composition may be a simple colorant or even a second film-forming composition containing a molecule that is not miscible in the first film-forming composition. This can be transposed to films without a support.

The second variant of the device is especially intended for obtaining a product constituted of a film on a support such is the case of patches for example. This variant contains, before casting of the film-forming mixture, a support 6b which may be a woven textile, a nonwoven textile or a flexible or non-flexible plastic or metal sheet (FIG. 5). An adhesion zone 6d may be provided on one face of the detachable support 6b corresponding to the face on which the film-forming zone 6a will be cast, namely the face which will be in contact with the skin in the case of a patch 6. This adhesion zone may however be constituted solely on the periphery of the support 6b or on a portion of this periphery, the adhesion being obtained by the use of a pressure-sensitive adhesive for example.

The support 6b is pinned to the base 4a, 4b of the cavity 4. A zone 10 for adhesion of the support 6b to the base 4a, 4b of the cavity 4 may be provided so that the support 6b is weakly fastened to the base 4a, 4b of the cavity 4 before casting the film-forming zone 6a. Thus, on opening the device, simple pulling on the patch 6 enables the release and use thereof.

The steps of curing and sealing a closure means 3 are similar to the variants described previously.

Moreover, the film-forming zone 6a may be cast in two goes over the pressure-sensitive adhesive support 6b, when two active principles that are incompatible as a mixture must be introduced into the same film-forming zone 6a or when the second layer confers the adhesivity on the support. In the latter case, the second film may be cast over the entire surface area of the support.

The base 4a, 4b of the cavity 4 according to the invention is essentially flat, that is to say that it may contain certain minor irregularities or microirregularities or a slight curvature or inclination but it retains a predominantly flat structure so as to allow the spreading of the mixture and a relatively constant thickness of the film 6.

Thus, FIGS. 5A and 5B illustrate a device having a flat base 4a and FIGS. 5C and 5D illustrate a device which according to a third variant comprises a base 4b of the cavity 4 that is slightly curved. In the case of a variant comprising a support 6b, according to a first subvariant, the support 6b may compensate for the hollow formed in the base 4b of the cavity 4, thus reestablishing a flat cavity base. It is thus possible to envisage a second subvariant in which the support 6b may reproduce the difference in level (FIG. 5C). In the latter case, the film-forming zone 6a obtained comprises a localized thicker part. In the case illustrated in FIG. 5D, this localization is central.

According to these variants equipped with a support 6b at the base 4a, 4b of the cavity 4, it is possible to envisage, before deposition of the film-forming mixture, the deposition of a liquid or semi-liquid composition or the deposition of a granular or solid compound directly on to the support 6b. Thus, the composition or the compound would be included between the two surfaces: the film-forming zone 6a on one side and the support 6b on the other; and the melting or simple bringing into contact of the film-forming zone 6a with the skin would allow the controlled release of the compound or of the composition or the adhesion of the patch. A similar result may be obtained by including the composition or compound between two layers of film-forming mixtures of a film.

According to preferred variants, the cavity wall 4c connecting the base of the cavity 4a to the flange 5 comprises a deformable zone 12a, 12b and a lower edge 4d. This deformable zone is deformed by folding 12a or twisting 12b so that a pressure (embodied in FIGS. 6 and 7 by double arrows) exerted on the base 4a (FIG. 6) or on the lower edge 4d of the cavity wall (FIG. 6) leads to a deformation of the cavity wall 4c enabling a raising of the base 4a of the cavity to the level of the flange 5 so as to facilitate the gripping of the film or of the patch (FIGS. 6 and 7).

The deformable zone 12a and 12b may extend over a portion of the side wall (FIG. 7) or over the whole of the wall (FIG. 6).

According to one advantageous variant, the base 4a comprises a peripheral groove 4e enabling a raising of the base 4a with respect to the lower edge 4d of the side wall 4c (FIG. 7). This raising of the base 4a facilitates the accessibility of the film during the deformation of the cavity wall 4c by pressure on the lower edge 4d. The central part of the base 4a may be flat (FIG. 7A) or a deposition zone 4f may be made therein (FIG. 7B). The deposition zone 4f surrounded by an edge 4g makes it possible to make a very small volume intended to receive a film-forming composition for the casting of the film.

According to another variant (see FIGS. 8A and 8B), the edge 4g constitutes a new deformation zone 12c allowing the film to be ejected from the deposition zone by exerting a pressure on the base of the deposition zone 4f. Alternatively, according to another variant, the deposition zone 4f constitutes, in its entirety, a deformation zone 12d (FIG. 8B) and allows the film to be ejected. In the absence of a peripheral edge 4g and therefore in the absence of delimitation of a deposition zone 4f, the deformation zone 12d may extend over the entire base 4a, 4b of the cavity 4. These two variants can be transposed to the films affixed to a support.

It should be noted that the deformation zone 12c, 12d situated on the base 4a, 4b of the cavity 4 may be independently provided with deformation zones 12a, 12b of the cavity walls or of the peripheral groove 4e. However, the combination of a first deformation zone 12a, 12b at the cavity wall, a peripheral groove 4e and a deformation zone 12a, 12b at the edge 4g or in the deposition zone 4f of the base 4a permits very easy accessibility of the films or patches obtained according to the invention.

The conditions for implementing the process according to the invention and non-exhaustive examples of compositions will be explained below.

### Examples of Orodispersible Films Containing Starch as Film-Forming Agent

### EXAMPLE 1

### Freshening Films

Production of the Mixtures:

The composition and the proportions are given in detail in table 1. Water is mixed with a plasticizer, namely glycerol (mixture E1), dibutyl sebacate (mixtures E2 and E4) or 25/75 propylene glycol/oleic acid (mixes E3 and E5). The colorant and the saccharinate are added to the mixtures and homogenized for 5 min. A stabilized liquefied pea starch sold under the name LYCOAT® NG73 sold by the applicant is then dispersed in each solution obtained so that the mixtures E1, E2, E3 contain 12% starch and the mixtures E4 and E5 contain 6% starch.

Each solution is mixed for 5 min then homogenized for 3 min then heated until it reaches a temperature of 70° C.

TABLE 1

| Composition | | E1 | E2 | E3 | E4 | E5 |
|---|---|---|---|---|---|---|
| Stabilized liquefied | | 60.20 | 57.5 | 57.5 | 28.75 | 28.75 |
| pea starch (g) | | | | | | |
| Plasticizer | Glycerol | 8.9 | | | | |
| (g) | Dibutyl | | 8.9 | | 4.45 | |
| | sebacate | | | | | |
| | Fluka | | | | | |
| | Propylene | | | 8.9 | | 4.45 |
| | glycol/oleic | | | | | |
| | acid 25/75 | | | | | |
| Flavoring | Mint | 11.15 | 11.15 | 11.15 | 5.6 | 5.6 |
| (g) | flavoring | | | | | |
| | Silésia | | | | | |
| | Menthol | 2.3 | 2.30 | 2.30 | 1.15 | 1.15 |
| Polysorbate (Tween 80) | | 0.4 | 0.4 | 0.4 | 0.2 | 0.2 |
| (g) | | | | | | |
| Soyabean lecithin (g) | | 0.4 | 0.4 | 0.4 | 0.2 | 0.2 |
| Sodium saccharinate (g) | | 2.3 | 2.3 | 2.3 | 1.15 | 1.15 |
| E133 blue colorant | | 4.45 | 4.45 | 4.45 | 2.2 | 2.2 |
| Silésia 2% DM (g) | | | | | | |
| Solvent (g) | Water | 409.9 | 412.6 | 412.6 | 456.3 | 456.3 |
| | Ethanol | | | | | |

| | | | | | |
|---|---|---|---|---|---|
| Total (g) | 500 | 500 | 500 | 500 | 500 |
| Temperature for the | 45 | 45 | 40 | 40 | 40 |
| deposition and viscosity | | | | | |
| measurement (° C.) | | | | | |
| Viscosity (mPa · s) | 2500 | 2200 | 2530 | 250 | 270 |

The mixtures are then cooled to 40 or 45° C. and the flavorings, the polysorbate and the soyabean lecithin are incorporated and mixed under vacuum for 10 min. The mixes are kept at 45° C. or at 40° C. in an oven until the filling of the cavities.

The viscosities of the mixtures (see table 1) are measured with the Brookfield RDVD-I+ viscometer machine, with the RV5 spindle for the mixtures E1, E2 and E3 and the RV3 spindle for the mixtures E4 and E5, at a speed of 20 rpm, at a temperature of 40° C. or 45° C., deposition temperature chosen in order to obtain an ideal viscosity of the mixture favorable to the spreading thereof in the cavity.

Variation of the Thickness of the Films as a Function of the Deposition Volume:

Various volumes of the mixture are deposited in the base of the cavity so as to obtain films of various thicknesses.

Volumes of V1, V2 and V3 are cast for the mixtures E1, E2 and E3, such that V1=0.4 cm³, V2=0.3 cm³ and V3=0.2 cm³.

The cavities are obtained from sheets of thermoformable plastic and have the following characteristics:
depth of 5 mm,
area of the base of the cavity 406 mm².

The drying is carried out by a microwave dryer so as to obtain films having a water content of less than 10%.

The microwave drying was carried out using a Pulsar ST22 microwave dryer from Microondes Energie Systemes (MES) according to two different conditions:
1. Speed of the belt: 5.25 m/min Microwave power: 100 W for 47 min then 200 W for 18 min
2. Speed of the belt: 5.25 m/min Microwave power: 300 W for 50 min.

The films obtained with the volumes deposited have a substantially equal thickness for the mixtures E1, E2 and E3 of the order of 200 μm (V1), 150 μm (V2) and 100 μm (V3).

These conditions made it possible to obtain films that were not bonded to the base of the cavity. These orodispersible films furthermore have very good taste qualities and good mouthfeel.

Variation of the Drying Techniques:

For the mixtures E1, E2 and E3, volumes of 0.3 cm³ were deposited. Various drying methods are tested including drying in an oven at 45° C. and reduced-pressure drying by establishing a vacuum and the combination of these two methods.
1/drying in an oven at 45° C. for 2 hours
2/drying at ambient temperature by establishing a vacuum (3608-Ic vacuum oven, LAB-LINE Instruments, Inc., Melrose Park, Ill., USA) for 3 hours
3/drying in an oven at 45° C. and by establishing a vacuum (3608-Ic vacuum oven, LAB-LINE Instruments, Inc., Melrose Park, Ill., USA) for 45 min.

These various drying methods resulted in films being obtained that had characteristics similar to those obtained by microwave drying, namely orodispersible films having very good organoleptic qualities and structures.

The technique of combining a reduction in pressure and heating at 45° C. enables a large reduction in the drying time and therefore favors the preservation of compounds that are unstable in aqueous solution.

### EXAMPLE 2

### Orodispersible Films with Active Principle

Composition E6 is obtained by firstly mixing water, glycerol a colorant (E133 Silésia) and saccharinate in the proportions described in table 2. The mixture is homogenized for 5 min. An active agent, Meloxicam is added as a mixture with the starch then homogenized for 3 min. The mixture is heated until it reaches a temperature of 70° C.

The mixture is then cooled to 45° C. and the flavorings, polysorbate and soyabean lecithin are incorporated and mixed under vacuum for 10 min. The mixture is kept at 45° C. in an oven until the filling of the cavities.

TABLE 2

| Composition | | E6 | E7 |
|---|---|---|---|
| Stabilized liquefied pea | | 28.75 | 28.75 |
| starch (g) | | | |
| Plasticizer | Glycerol | 4.45 | |
| (g) | Dibutyl sebacate | | 4.45 |
| | Fluka | | |
| Flavoring | Mint flavoring | 5.6 | 5.6 |
| (g) | Silésia | | |
| | Menthol | 1.15 | 1.15 |
| Polysorbate (Tween 80) (g) | | 0.5 | 0.2 |
| Soyabean lecithin (g) | | 0.5 | 0.2 |
| Active agent | Meloxicam | 12.5 | |
| (g) | Loperamide HCl | | 3.5 |
| Sodium saccharinate (g) | | 1.15 | 1.15 |
| E133 blue colorant Silésia | | — | 2.2 |
| 2% DM (g) | | | |
| Solvent (g) | Water | 345.4 | 452.8 |
| | Ethanol | 100 | |

| | | |
|---|---|---|
| Total (g) | 500 | 500 |
| Temperature for the deposition | 45 | 40 |
| and viscosity measurement (° C.) | | |
| Viscosity (mPa · s) | 280 | 240 |

The viscosities of the mixtures (see table 2) are measured with the Brookfield RDVD-I+ viscometer machine with the RV3 spindle at a speed of 20 rpm, at a temperature of 45° C., deposition temperature chosen to obtain an ideal viscosity of the mixture favorable to the spreading thereof in the cavity.

The mixture E7 is obtained in the same way as the mixtures E1 to E5, the active agent being added to the mixture alone before the addition of the starch then homogenized for 5 min.

0.3 cm of mixes E6 and E7 is deposited per cavity and half of the total is put in an oven at 45° C. overnight in order to dry and half is left at ambient temperature overnight.

Since the drying at ambient temperature is milder than that in an oven at 45° C., films that have a higher moisture content, therefore films that are less brittle, are obtained with drying at ambient temperature.

Example of Orodispersible Films Containing Polyethylene Film-Forming Accent

TABLE 3

| Composition | E8 |
|---|---|
| Polyethylene glycol 4000 (g) | 392.5 |
| Dextromethorphan HBR | 7.5 |
| Viscosity at 60° C. (mPa · s) RV3 spindle | 550 |

The film-forming composition E8 is obtained from polyethylene glycol without addition of solvent (see table 3), the polyethylene glycol being in liquid form by melting at 60° C. The viscosity measurements (table 3) are carried out as before.

800 mg are deposited in each cavity, which corresponds to a unit dose of 15 mg of dextromethorphan.

The films are cured at ambient temperature by cooling the deposits. Orodispersible films having good textures are obtained.

1. A process for manufacturing a film (6) comprising the following steps:
a) preparing a film-forming mixture comprising at least one film-forming agent,
b) depositing a dose of said mixture into a cavity of a cavity support, the mixture having a viscosity of 1 to 8000 mPa·s at the temperature of said film-forming mixture during the deposition step b),
c) curing of said mixture so as to obtain a film (6),
d) closing said cavity (4) by a hermetic closure means (3).

2. The process as claimed in claim 1, in which the steps b) and c) are repeated at least once before step d).

3. The process as claimed in claim 1, characterized in that a step of depositing a granular or solid compound or a semi-liquid or liquid preparation in said cavity (4) before step d) is provided.

4. The process as claimed in claim 3, characterized in that said step of depositing a granular or solid compound or a semi-liquid or liquid preparation is a printing step.

5. The process as claimed in claim 1, characterized in that the curing step c) is a step of cooling the mixture or a step of evaporating a solvent contained in said film-forming mixture.

6. The process as claimed in claim 5, characterized in that the step of evaporating said solvent is carried out by increasing the temperature of the mixture, by varying the pressure or by a combination thereof.

7. The process as claimed in claim 1, characterized in that the mixture comprises:
from 40 to 99% by weight of film-forming agent,
at least 1% by weight of an additive.

8. The process as claimed in claim 1, characterized in that the film-forming agent comprises a starch or a mixture of starches.

9. The process as claimed in claim 1, characterized in that the film-forming agent comprises a legume starch, preferably pea starch.

10. The process as claimed in claim 1, characterized in that the process comprises a step of producing said cavity support (2).

11. A device (1) capable of containing a film (6) characterized in that it comprises a cavity support (2) provided with a cavity (4) and a means (3) of closing said cavity support (2), said cavity (4) being surrounded by a transverse flange (5) comprising a hermetic sealing zone (7), said cavity (4) being provided with an essentially flat base (4a; 4b), said base (4a; 4b) having an area greater than 1 cm² per millimeter of depth of said cavity (4).

12. The device (1) as claimed in claim 11, characterized in that it is provided with a deformation zone (12a; 12b; 12c; 12d).

13. The device (1) as claimed in claim 11, characterized in that said cavity (4) is provided with a detachable support (6b), positioned at the base (4a; 4b) of said cavity (4).

14. The device (1) as claimed in claim 13, characterized in that said detachable support (6b) is provided on at least one of its edges with an adhesion zone (6d) intended to be applied and to adhere to a surface.

15. The device as claimed in claim 11, characterized in that said cavity (4) comprises a film.

16. An assembly formed by joining several devices (1) as claimed in claim 11 forming a blister pack (P).

17. A unit for carrying out the process as claimed in claim 1, characterized in that it comprises the succession of the following means:
means for manufacturing and homogenizing the film-forming mixture,
means for depositing the film-forming mixture,
means for curing the mixture,
means for hermetically closing the cavities (4) and if desired
printing means.

18. The unit as claimed in claim 17, characterized in that it comprises means for producing a device (1) capable of containing a film (6) and comprising a cavity support (2) provided with a cavity (4) and a means (3) for closing said cavity support (2), said cavity (4) being surrounded by a transverse flange (5) comprising a hermetic sealing zone (7), said cavity (4) being provided with an essentially flat base (4a; 4b), said base (4a; 4b) having an area greater than 1 cm² per millimeter of depth of said cavity (4).

19. The process as claimed in claim 2, characterized in that a step of depositing a granular or solid compound or a semi-liquid or liquid preparation in said cavity (4) before step d) is provided.

20. The device (1) as claimed in claim 12, characterized in that said cavity (4) is provided with a detachable support (6b), positioned at the base (4a; 4b) of said cavity (4).
